(19) United States
(12) Patent Application Publication
(10) Pub. No.: US 2009/0019435 A1
(43) Pub. Date: Jan. 15, 2009

(54) SYSTEM AND METHOD FOR OVER THE AIR PROGRAMMING

(75) Inventors: Todd A. Piechowski, Buffalo, MN (US); Fred Bezat, Eden Prairie, MN (US)

Correspondence Address: ZARLEY LAW FIRM P.L.C., CAPITAL SQUARE, 400 LOCUST, SUITE 200, DES MOINES, IA, 50309-2350, US

(73) Assignee: SAUER-DANFOSS INC., Ames, IA (US)

(21) Appl. No.: 11/776,678

(22) Filed: Jul. 12, 2007

(51) Int. Cl. G06F 15/177; G06F 9/44

(52) U.S. Cl. 717/176; 713/2

(57) ABSTRACT

A method for programming computer code at a remote platform having a local computer. A home device sends a computer code to the local computer via wireless transmission wherein the computer code is stored within an alternate area of a flash memory. Once a complete copy of the computer code is recognized at the local computer the integrity of the computer code is checked and if proper, a new boot address is assigned at the local computer. At this time the local computer is rebooted such that when the computer restarts the alternate computer code is used thus effectively updating the computer software.

### BACKGROUND OF THE INVENTION

The present invention relates to an over the air programming system and method of using the same. More specifically, the present invention relates to a method of programming computer code at a remote platform.

Over the air programming (OTAP) systems for communicating information to a remote or mobile device or vehicle are known in the art. Often times the mobile device has a local computer that receives wireless over the air communication from a home device. The local computer specifically contains a microcontroller, memory systems and the like in order to provide various functions for a user. Specifically, the local computer has a plurality of applications, systems, programs, or the like that provide different operating modes and functions of the local computer for a user.

In the art when an application, system, program or the like needs to be updated the home device sends a signal to the remote device providing the local computer with a plurality of computer code packets that comprise a computer code to update a system, program, application, or the like in the local computer. Presently, in the art when the computer code is received the local computer reboots, and during the rebooting process, checks the integrity of the code in order to determine whether the update is proper.

Though effective at updating the local computer this process can be time consuming. Specifically, because the program must be analyzed and checked to determine whether the integrity of the code is proper during the rebooting process, a user has to wait for the checking of the integrity of the code before being able to continue the operation of the local computer. This delay in time cannot only be annoying to a user but additionally is inefficient.

Thus, a principal object of the present invention is to provide an efficient manner in updating a computer.

Yet another object of the present invention is to provide a method that maximizes the time for operator use even when a computer is being updated.

These and other objects, features, or advantages of the present invention will become apparent from the specification and claims.

### BRIEF SUMMARY OF THE INVENTION

A method for programming computer code at a remote platform having local computer, the local computer including a flash memory. The method includes receiving a plurality of computer code packets wherein the computer code packets are provided by wireless transmission. The next step involves storing the plurality of code packets in an alternate area of flash memory of the local computer wherein the plurality of computer code packets comprise a computer code. The local computer then recognizes the reception of the complete copy of the computer code and checks the integrity of the received computer code before the rebooting process. In response to checking the integrity of the computer code a boot address of the local computer is changed such that at the convenience of a user the local computer may be rebooted after the boot address is changed. Once the local computer is rebooted the computer restarts with the alternate computer code wherein there is not a need to check the integrity of the computer code during the rebooting process.

### BRIEF DESCRIPTION OF THE DRAWINGS

FIG. 1 is a block diagram of a system for over the air programming;

FIG. 2 is a block diagram of a local computer designed to receive the over the air programming;

FIG. 3 is a block diagram of code within a alternate area of flash memory;

FIG. 4 is a diagram of a message used in the system of FIG. 1 to transmit programming; and

FIG. 5 is a flow chart of processes used to implement over the air programming.

### DETAILED DESCRIPTION OF THE PREFERRED EMBODIMENT

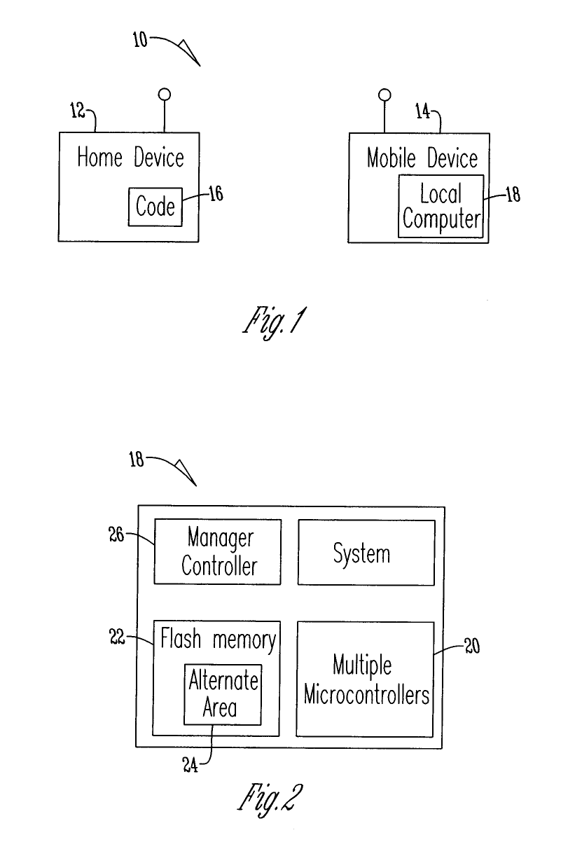

FIG. 1 shows an over the air programming system 10 having a home device 12 and a remote platform 14 that receives over the air signals from the home device 12. In a preferred embodiment the remote platform 14 is a mobile device such as a vehicle. The home device 12 specifically contains a plurality of computer code packets 16 that are transmitted to the remote platform 14 wherein they are received by a local computer 18.

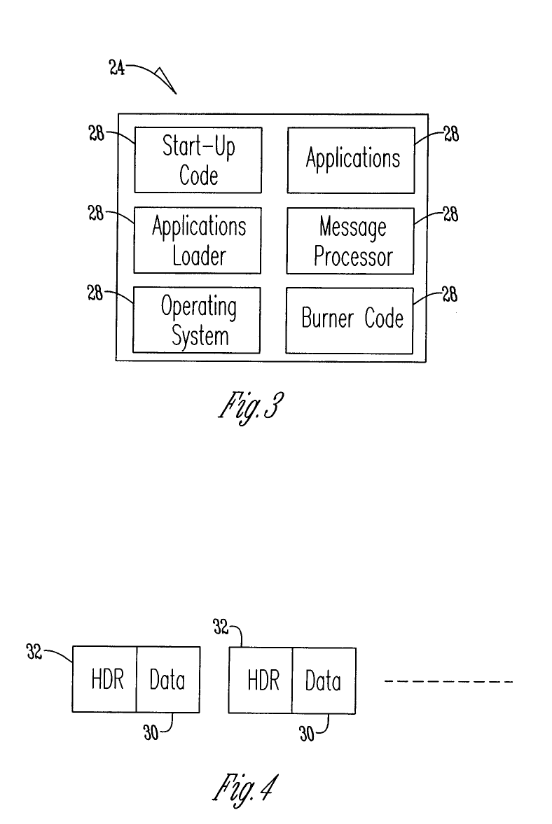

The local computer 18 as best shown in FIG. 2 has a plurality of operating systems/applications/programs or the like therein that control the operation of the local computer 18. These systems/applications/programs include but are not limited to a microcontroller 20, a flash memory 22 having an alternate area 24, a manager controller 26 or the like. Specifically, other memories and the like, as is known in the art, reside within the local computer 18. The local computer 18 receives the transmission from the home device 12 and in a preferred embodiment a manager controller 26 receives a plurality of computer code packets 16 that comprise a computer code. In this embodiment the computer code can comprise a plurality of applications that may be down loaded to distributed processors such as embedded valve section controllers, embedded pump processors, distributed micro controllers, I/O modules or the like. Thus, the local computer 18 is able to receive a plurality of applications within a manager controller 26.

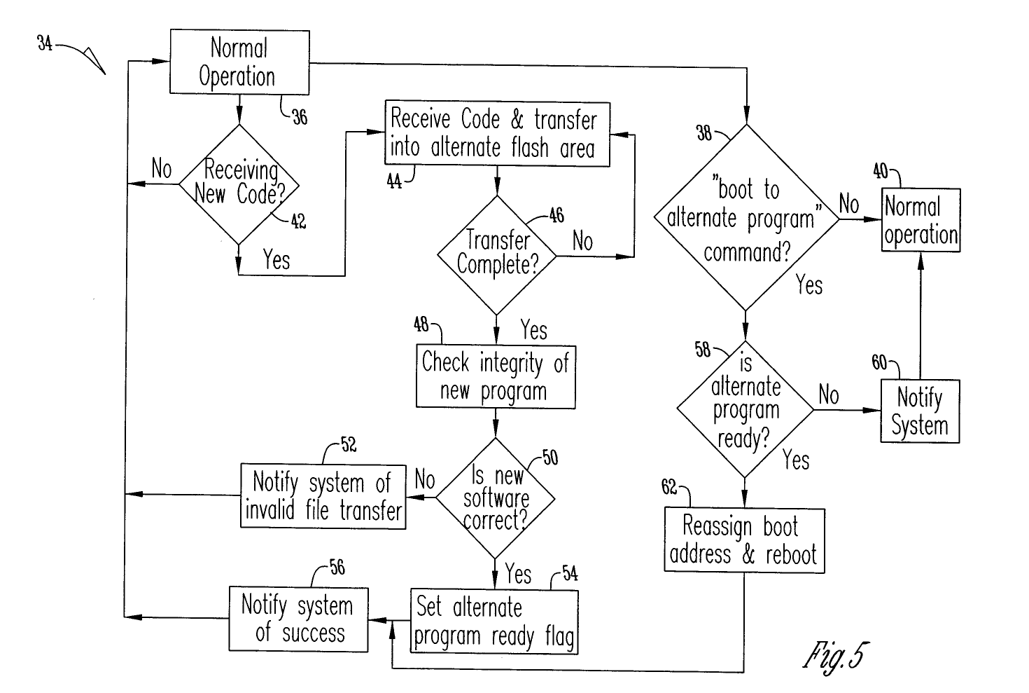

FIG. 3 shows the programming of the alternative area 24 of flash memory 22. Specifically, the alternate area 24 is software that contains a plurality of components 28 such as startup code, applications loader, applications, message processor, operating system, burner code, and the like. By using these components 28 the software is able to receive updates and implement such updates. Thus, the local computer 18 is able to receive update software (See FIG. 4) having data 30 and a header segment 32 (HDR) and use this updated software or computer code packet 16 to update software in the local computer 18.

FIG. 5 shows how the software 34 within the flash memory 22 operates to update the software within the local computer 18. Specifically, at block 36 the software is operating normally. Before receiving a new code via a plurality of computer code packets, the software 34 monitors the system to determine whether a boot to alternate program command is provided at block 38. When an alternate program is not yet ready, normal operation commences at block 40.

The software 34 continually monitors at block 42 to determine if a plurality of computer code packets have been received to provide a new code. If not, normal operation at block 36 commences. However, if new code is detected at block 42, at block 44 that code is received and transferred into the alternate flash area 24. At this time a decision is made at block 46 and if the software 34 determines that the transfer of the new code is not complete, the software 34 continues to transfer code to the alternate flash area 24. If the transfer is complete at block 46 the integrity of the new code, or program, is determined at block 48.

Thus, at block 48 the integrity of a new code is checked before rebooting the local computer 18 and the software 34 allows a user to continue to operate the local computer 18 even as the integrity of the program is being checked at block 48. Thus, the integrity of the new program, or code, does not have to be checked during the rebooting process.

Therefore, at block 50 a decision is made whether the new computer code is correct and if not, the software 34 notifies the local computer 18 of an invalid file transfer at block 52. However, if the new computer code is correct the software 34 sets the alternate program at block 54. Once the alternate program is ready at block 54 the software 34 notifies the local computer 18 of the successful transfer at block 56 and normal operation at block 36 continues as a computer user additionally continues operation of the local computer 18.

At this time decision 38 regarding whether to boot to the alternate program 26 command is provided and because an alternate program is ready at block 54, at block 58 the software 34 can determine whether the alternate program is ready. If not, at block 50 the local computer 18 is notified whereas if the alternate program is ready at block 58 the software 34 reassigns or changes the boot address of the local computer 18 and reboots the local computer 18 at block 62. During the rebooting process the local computer 18 restarts with the alternate computer code such that the update is provided.

Because the software 34 is able to determine the integrity of the computer code received during the operation of the local computer 18 the step of checking the integrity of the program does not have to be taken during the rebooting process thus minimizing the rebooting time. Similarly, this maximizes the efficiency of a user as the checking of the integrity of the program can be done simultaneously during user operation. Thus, at the very least all of the stated objectives have been met.

It will be appreciated by those skilled in the art that other various modifications could be made to the device without the parting from the spirit in scope of this invention. All such modifications and changes fall within the scope of the claims and are intended to be covered thereby.

What is claimed is:

1. A method for programming computer code at a remote platform having a local computer, the local computer including a flash memory the method comprising:
receiving a plurality of computer code packets, wherein the plurality of computer code packets are provided by wireless transmission;
storing the plurality of computer code packets in an alternate area of flash memory of the local computer wherein the plurality of computer code packets comprise the computer code;
recognizing reception of a complete copy of the computer code at the local computer;
checking the integrity of the received computer code;
in response to such checking, changing a boot address of the local computer;
rebooting the local computer after the boot address is changed; and
in response to rebooting the local computer restarting the local computer with an alternate computer code.

2. The method of claim 1 wherein the remote platform is a mobile platform.

3. The method of claim 1 wherein the computer code comprises a plurality of applications.

4. The method of claim 1 wherein a manager controller receives the plurality of computer code packets that comprise the computer code.

5. The method of claim 4 wherein the computer code comprises a plurality of applications.

6. The method of claim 5 wherein the plurality of applications include at least one of: valve sections, embedded pump processor, or micro controllers.

7. The method of claim 1 wherein during the step of checking the integrity of the received computer code the local computer runs a previous application.

8. The method of claim 3 wherein the plurality of applications are downloaded to multiple processors in a distributed control system architecture.
